(19) United States
(12) Patent Application Publication
(10) Pub. No.: US 2009/0223075 A1
(43) Pub. Date: Sep. 10, 2009

(54) GAGE FOR MEASURING DRUM BRAKE INSIDE DIAMETER

(76) Inventor: Lin WO, Nanjing City (CN)

Correspondence Address: STANDLEY LAW GROUP LLP, 6300 Riverside Drive, Dublin, OH, 43017, US

(21) Appl. No.: 12/400,313

(22) Filed: Mar. 9, 2009

Related U.S. Application Data
(60) Provisional application No. 61/034,655, filed on Mar. 7, 2008.

(51) Int. Cl. G01B 5/08; G01B 1/00

(52) U.S. Cl. 33/811; 33/610

(57) ABSTRACT

A device for measuring an inside diameter of a drum brake has a generally planar beam with a readout member slidingly mounted for longitudinal translation along the beam. A face of the readout member is adapted for display of a distance measurement that is obtained from a measuring device also on the readout member. First and second measuring jaws extend outwardly from the beam in a direction that is normal to both a longitudinal and a transverse axis of the beam, the first measuring jaw being affixed to the beam inwardly from a first end of the beam, leaving a portion of the beam between the first end and the first measuring jaw and the second measuring jaw affixed to the readout member. Measuring tips, extending in opposite directions are affixed to the respective measuring jaws.

### CROSS-REFERENCE TO RELATED APPLICATIONS

This application is a non-provisional of on that and makes no claim of priority. This application is a non-provisional of, and makes claim of the benefit of priority to, U.S. provisional patent application Ser. No. 61/034,655, filed 7 Mar. 2008, which is incorporated by reference as if fully recited herein.

### TECHNICAL FIELD

This application relates to the field of gages, particularly, to the field of gages for measuring the largest inside diameter of a drum brake.

### BACKGROUND OF THE ART

In the field of maintaining drum brakes, it is important and known to measure certain aspects of a drum brake to a high degree of accuracy and precision. One measurement that is required is a determination of the largest inside diameter that is encountered in the brake.

While it is desirable that a drum brake have a consistent value of the inside diameter as one moves around the circumference of a drum brake, actual observation is that the inside diameter will vary.

At least two problems exist in the known prior art gages for measuring drumbrake inside diameters. First, obtaining a consistently diametric value is difficult, as it is easy with many gages to skew the gage slightly off of the diameter. Second, and in part due to the first problem, the known gages make the act of obtaining accurate results and simultaneously recording these results in a useful manner a difficult task.

Therefore, it is an unmet objective of the prior art as known to provide a gage for both accurately and precisely measuring the inside diameter of a drum brake.

### SUMMARY OF THE INVENTION

This and other objectives are achieved by a gage for measuring a drum brake with a generally planar beam. A readout member is mounted for sliding movement along the length of the beam. A face of the readout member is adapted for display of a measurement reading and the readout member is provided with a means for measuring a distance of the sliding movement along the length of the beam. One example of the means for measuring distance is a vernier.

First and second measuring jaws are also provided. The first measuring jaw extends outwardly from the beam in a direction that is normal to both a longitudinal and a transverse axis of the beam and the second measuring jaw extends outwardly from the readout member on a side thereof opposite the face, so that it is parallel to the first measuring jaw.

The first measuring jaw is affixed to the beam inward from a first end of the beam, leaving a portion of the beam between the first end and the first measuring jaw and is provided with a measuring tip that extends parallel to the beam longitudinal axis of the beam, in the direction of the first end of the beam.

To accommodate the second measuring jaw, the beam is provided, in some instances, with a longitudinal slot through which the second measuring jaw extends. IN other instances, the readout member extends around the transverse edges of the beam to allow the second measuring jaw to extend in the same direction as the first measuring jaw.

Each of the measuring jaws is provided with a measuring tip. The measuring tips are aligned with each other, although they extend in opposite directions.

In many aspects of the invention, means for effecting translation of the readout member relative to the beam are provided on at least one of the readout member and the beam. A typical means would be a knob for a user to grasp. The beam should be sufficiently long to span the inside diameter of the drum brake to be measured. When a portion of the beam between the first end and the first measuring jaw is rested upon the rim of the drum brake with the respective jaws extending into the central cavity of the drum brake, the inside diameter may be readily determined by securing the first measuring jaw into place and moving the second measuring jaw along the opposite circumference, recognizing that the lengths of the chords being measured thereby will be maximized when the beam is aligned along the true diameter.

### BRIEF DESCRIPTION OF THE DRAWINGS

A better understanding of the invention will be had by reference to the accompanying figures, wherein identical parts are identified by identical part numbers and wherein:

FIG. 1 is a side elevation view of a drum brake gage as known in the prior art;

FIG. 2 is a side elevation view of an embodiment of the drum brake gage, in isolation;

FIG. 3 is a perspective view of the FIG. 2 embodiment;

FIG. 4 is a schematic depiction of an exemplary readout member of the FIG. 2 embodiment, showing particular details of the display face;

FIG. 5 is a side elevation view of the FIG. 2 embodiment, operatively engaged in a drum brake; and

FIG. 6 is a perspective view of the operative engagement shown in FIG. 5.

### DETAILED DESCRIPTION OF THE DRAWINGS

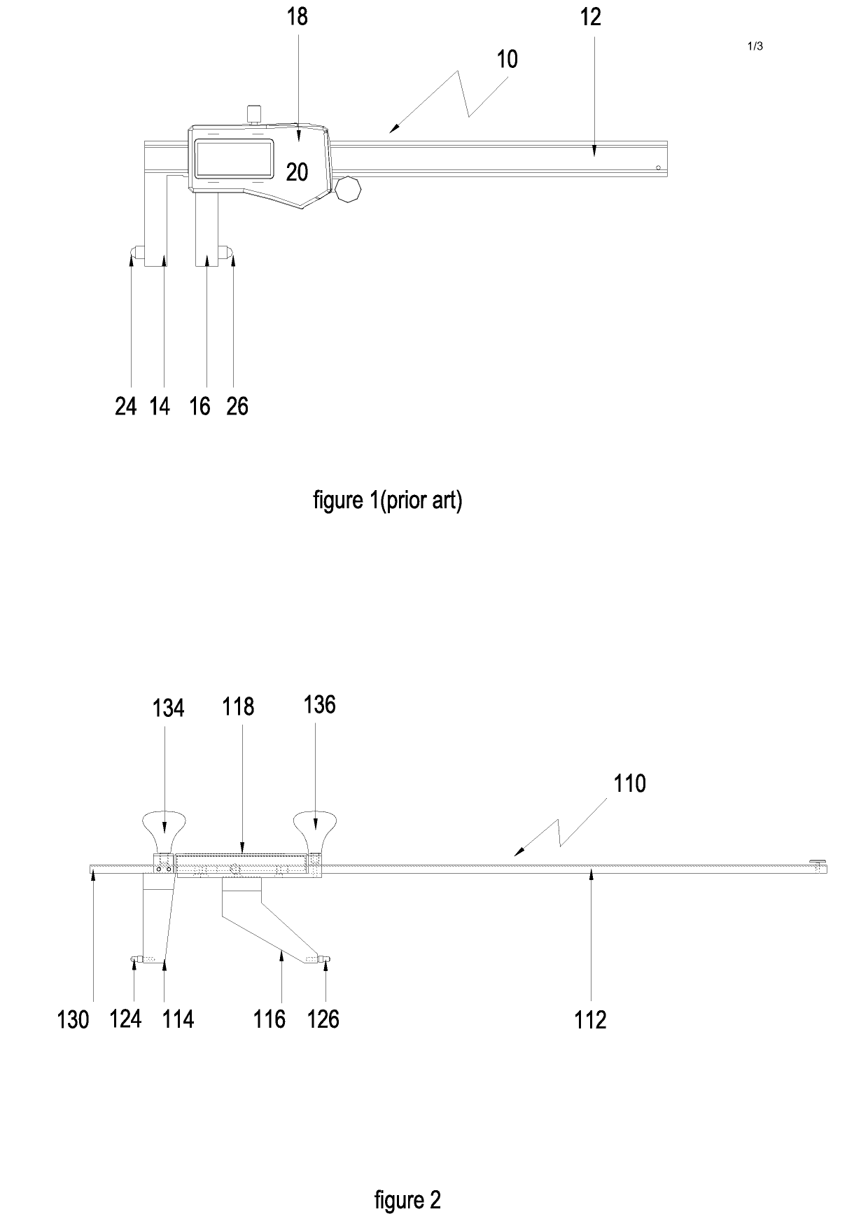

Referring first to FIG. 1, a digital drum brake gage 10 as is generally known in the prior art is shown in a side elevation view. In this view, the gage 10 is seen as having a generally planar beam 12, with a first measuring jaw 14 that extends outwardly from the beam in an essentially co-planar manner and a second measuring jaw 16. The second measuring jaw 16 also extends outwardly from the beam 12 in an essentially co-planar manner. However, instead of being affixed to the beam 12, as the first measuring jaw 14 is affixed, the second measuring jaw 16 is affixed to a readout member 18 that is slidingly mounted on the beam. The readout member has a face 20 on which a measurement reading may be displayed. The first jaw 14 is a fixed jaw, and is affixed at an end of the beam 12.

Each of the measuring jaws 14, 16 has a measuring tip, with tip 24 on jaw 14 and tip 26 on jaw 16. The respective jaws and tips are arranged so that the tips 24 and 26 face away from each other and, as tip 26 moves relative to tip 24 when readout member 18 slides along beam 12, the tips move along a line parallel to a longitudinal axis of the beam 18.

In the known arrangement illustrated, the face 20 of the readout member is located on a plane that is parallel to the plane of the beam 12. As seen in FIG. 1, the body of the readout member 18 is wider than the beam, particularly on the side of the beam from which the jaws extend.

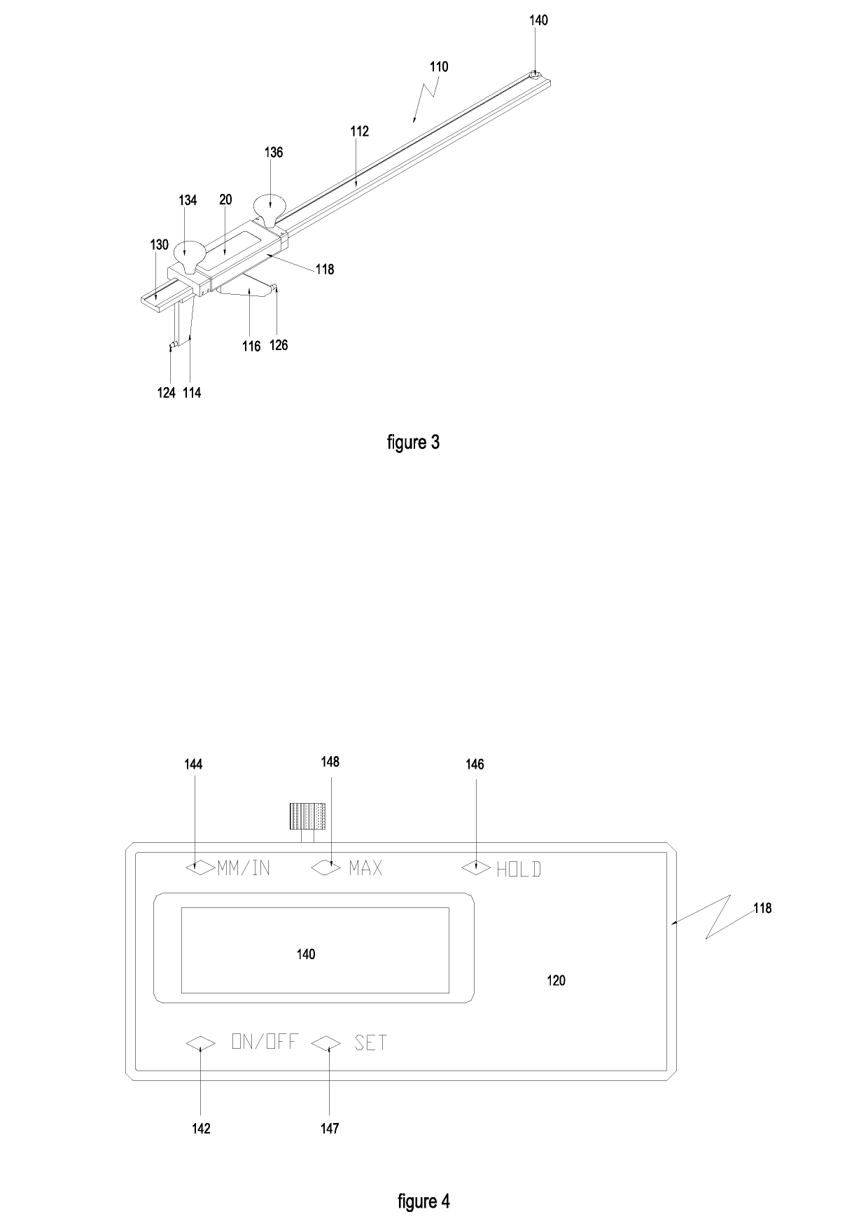

Moving now to FIGS. 2 and 3, an embodiment of the drum brake gage 110 containing the inventive aspects of this application is shown in side elevation and perspective views, respectively. One immediately notable feature is the placement of the jaws 114, 116. In this embodiment, the jaws are deployed normal to the plane of generally planar beam 112, rather than being essentially co-planar. The first measuring jaw 114 is affixed to the beam 112 slightly inward from a first end of the beam, the portion 130 of the beam between the first end and the first jaw 114 providing a valuable function, as will be explained below. First measuring jaw 114 is provided with a measuring tip 124 that extends parallel to a longitudinal axis of the beam 112, in the direction of the first end of the beam. The second measuring jaw 116 is affixed to a readout member 118 that slidingly rides atop the beam 112. The readout member 118 has a face 120 on which a measurement reading may be displayed.

To allow the readout member 118 to ride atop the beam and the second measuring jaw 116 to extend normal to the beam on the opposite side of the beam from the readout member, as seen in FIGS. 2 and 3, either the beam is provided with an open slot through which the second jaw extends, or the readout member extends around the beam. Second measuring jaw 116 is equipped with tip 126. In the manner shown in the prior art example, the respective jaws 114, 116 and their tips 124, 126 are arranged so that the tips face away from each other. As tip 126 moves relative to tip 124 when readout member 118 slides along beam 112, the tips move along a line parallel to a longitudinal axis of the beam 12.

FIGS. 2 and 3 show that a first knob 134 is fixed to the combined beam 112/first measuring jaw 114, the first knob extending from the beam opposite the first jaw, at least as shown in the illustrated embodiment. A second knob 136 is fixed to the combined readout member 118/second measuring jaw 116, the second knob extending from the readout member opposite the second jaw, at least as shown in the illustrated embodiment.

While not explicitly shown in either the prior art embodiment 10 of FIG. 1 or the inventive embodiment 110 of FIGS. 2 and 3, the respective readout members 18, 118 will be understood by those of skill in the art to each be provided with a vernier or similar mechanism, through which a distance between the respective tips is determined

Movement of the readout member 118 along the beam 112 is delimited at the first end by the fixed first measuring jaw 114. At the second end of the beam 112, an end stop of some manner should be provided, with an exemplary end stop 140 shown in FIGS. 2 and 3.

Additional detail of the readout member 118, and, especially, the display face 120 is shown in top plan view in FIG. 4. Prominent on the display face 120 is a display area 140, which will be filled by a display means, typically a liquid crystal diode (LCD). Various control buttons are depicted. Among these are an “on/off” function button 142, a units selection button 144, a “hold” button 146, a “set” button 147 and a “max” button 148. Of particular note is the “max” button 148. Internal to the readout member is a digital chip for operating the readout member 118, as well as a power source, typically a small battery. Integral to the digital chip is a logic circuit that allows the maximum measured distance value to be stored in a memory register. Use of the “max” button 148 causes the value stored in the memory register to be displayed.

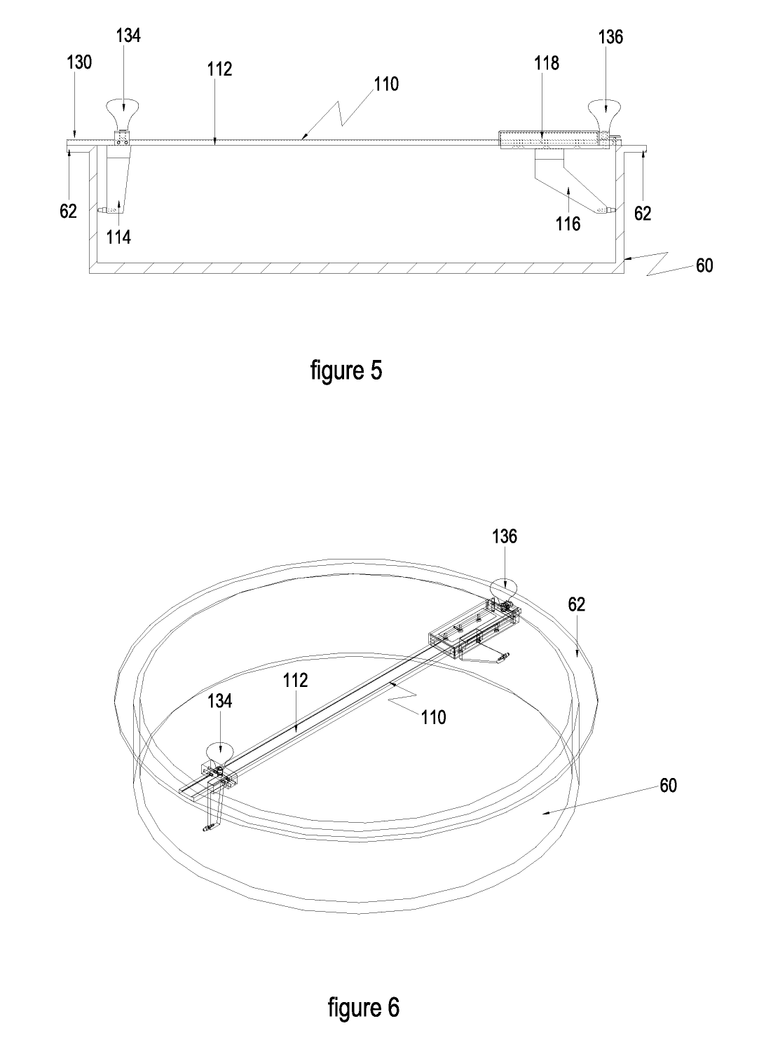

Use of the device 110 on a typical drum brake 60 is shown in FIGS. 5 and 6. Beam 112 has a length sufficient to span the inside diameter of the drum brake 60, with enough additional length to allow a flat lower surface of beam 112 to be placed on the rim 62 thereof, with the jaws 114, 116 extending in to the central cavity of the drum brake. Because fixed first jaw 114 is positioned inwardly from the first end of the beam 112, the beam portion 130 rests on the rim, such that first knob 134 and tip 124 of jaw 114 are useful in snugging the first end of the device against the inside wall of the drum brake 60. From this point, a visual alignment of the device 110 is made across the top rim 62, with the intent of aligning the tips 124, 126 with the diameter. Obviously, this process is preferably started with the second tip (and with it, the readout member 118) drawn inwardly from the second end of the beam.

With the device 110 positioned in this manner, the digital chip of the readout member 118 powered up and the maximum value register either “zeroed” or set to a value that is clearly smaller than the diameter, the second jaw 116 is moved towards the second end of the beam 112, using the second knob 136 and keeping the second end of the beam in resting contact with the top rim surface, until the tip 126 contacts the inside face. Keeping in mind that the longest chord of a circle is its diameter, and keeping the tips 124, 126 in contact with the inside wall surface, slight lateral movement of the tips will seek out the true diameter, which will be recorded as the maximum value.

What is claimed is:

1. A device for measuring an inside diameter of a drum brake comprises:
a generally planar beam;
a first measuring jaw, extending outwardly from the beam in a direction that is normal to both a longitudinal and a transverse axis of the beam;
a readout member, mounted for sliding movement along the length of the beam, a face of the readout member adapted for display of a measurement reading, the readout member provided with means for measuring a distance of the sliding movement along the length of the beam; and
a second measuring jaw, extending outwardly from the readout member on a side thereof opposite the face, parallel to the first measuring jaw.

2. The device of claim 1, wherein:
the first measuring jaw is affixed to the beam inward from a first end of the beam, leaving a portion of the beam between the first end and the first measuring jaw.

3. The device of claim 2, further comprising:
a measuring tip on the first measuring jaw, the measuring tip extending parallel to the beam longitudinal axis, in the direction of the first end of the beam.

4. The device of claim 3, wherein:
the beam is provided with a longitudinal slot through which the second measuring jaw extends.

5. The device of claim 3, wherein:
the readout member extends around the transverse edges of the beam to allow the second measuring jaw to extend in the same direction as the first measuring jaw.

6. The device of claim 3, further comprising:
a measuring tip on the second measuring jaw, the second measuring tip aligned with, and extending in an opposite direction from, the first measuring tip.

7. The device of claim 1, further comprising:
means, provided on at least one of the readout member and the beam, for effecting translation of the readout member relative to the beam.

8. The device of claim 7, wherein:
the translation means comprises at least one knob for grasping by a user.

9. The device of claim 1, wherein:
the means for measuring distance is a vernier.

11. The device of claim 2, wherein:
the beam is sufficiently long to span the inside diameter of the drum brake to be measured.

12. The device of claim 11, wherein:
the beam portion between the first end and the first measuring jaw is sufficiently long to allow a the portion, on the surface of the beam opposite the readout member, to be placed on a rim of the drum brake with the respective jaws extending into the central cavity of the drum brake.

13. A device for measuring an inside diameter of a drum brake comprises:
a generally planar beam;
a first measuring jaw, affixed to, and extending outwardly from, the beam in a direction that is normal to both a longitudinal and a transverse axis of the beam, the first measuring jaw affixed to the beam inwardly from a first end of the beam, leaving a portion of the beam between the first end and the first measuring jaw;
a measuring tip on the first measuring jaw, the measuring tip extending parallel to the beam longitudinal axis of the beam, in the direction of the first end of the beam
a readout member, mounted for being slidingly translated along the length of the beam by a user;
a second measuring jaw, extending outwardly from the readout member, parallel to the first measuring jaw; and
a measuring tip on the second measuring jaw, the second measuring tip aligned with, and extending in an opposite direction from, the first measuring tip.
